(19) United States
(12) Patent Application Publication
(10) Pub. No.: US 2008/0228823 A1
(43) Pub. Date: Sep. 18, 2008

(54) FRAME TRANSFER APPARATUS

(75) Inventor: Kazuaki YOSHIDA, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/044,440

(22) Filed: Mar. 7, 2008

(30) Foreign Application Priority Data
Mar. 16, 2007 (JP) 2007-068524

(51) Int. Cl. G06F 17/30

(52) U.S. Cl. 707/104.1; 707/206; 707/E17.009

(57) ABSTRACT

A frame transfer apparatus has a common storage unit having a plurality of areas. The frame transfer apparatus has a write control unit that stores a transmitted frame in an area fitting to the frame of the plurality of areas. The frame transfer apparatus has a read control unit that reads the frame stored in the area in order of storage. The frame transfer apparatus has clock units each provided by associating with one or more areas among the plurality of areas to measure a time after a frame is stored in a corresponding area. The frame transfer apparatus also has a frame discarding unit that, when a measured time by any clock unit among the clock units exceeds a permissible retention time, discards among frames stored in the area corresponding to the clock unit at least a frame positioned first.

### CROSS-REFERENCE TO RELATED APPLICATIONS

This application is related to and claims priority to Japanese patent application no. 2007-68524 filed on Mar. 16, 2007, in the Japan Patent Office, and incorporated by reference herein.

### BACKGROUND

1. Field

The embodiments relate to a so-called common buffer type frame transfer method, apparatus, and computer readable medium, temporarily storing a transmitted frame in a FIFO memory fitting to the frame of a common buffer composed of a plurality of FIFO (First-In First-Out) memories and then reading the frame from the FIFO memory for transmission.

2. Description of the Related Art

A common buffer type frame transfer apparatus as described above is used in a network in which data in the frame format flows. Here, in a conventional common buffer type frame transfer apparatus, a frame once written into a buffer remains in the buffer until read permission is granted. When read control in which the QoS (Quality of Service) technology based on class priority control is applied is performed, the order in which read permission comes around is determined in accordance with frame priorities. In complete priority selection processing based on class priority read control, frames of higher priority classes are always read preferentially and frames whose priority class is lower than such classes are permitted to be read only when no frame whose priority class is higher than the classes exists in the buffer (Refer to Japanese Patent Application Laid-Open (JP-A) No. 11-122257).

When input exceeding the read band of frames is done, the amount of frames remaining in the buffer can be controlled by discarding frames when the preset buffer amount is exceeded. In this case, frames overflowing the buffer are discarded in reverse order of arrival. That is, the buffer amount is controlled by discarding the latest or most recently received/arrived frame (Refer to JP-A-2003-188912).

### SUMMARY

According to an aspect of an embodiment, a frame transfer apparatus has a common storage unit having a plurality of areas. The frame transfer apparatus has a write control unit that stores a transmitted frame in an area fitting to the frame of the plurality of areas. The frame transfer apparatus has a read control unit that reads the frame stored in the area in order of storage. The frame transfer apparatus has clock units each provided by associating with one or more areas among the plurality of areas to measure a time after a frame is stored in a corresponding area. The frame transfer apparatus also has a frame discarding unit that, when a measured time by any clock unit among the clock units exceeds a permissible retention time, discards among frames stored in the area corresponding to the clock unit at least a frame positioned first.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a functional block diagram of an internal configuration of a frame transfer apparatus including a first communication state in a first embodiment;

FIG. 2 is a functional block diagram of the internal configuration of the frame transfer apparatus including a second communication state in the first embodiment; and

FIG. 3 is a diagram showing a frame transfer apparatus in a second embodiment.

### DETAILED DESCRIPTION OF THE PREFERRED EMBODIMENTS

Embodiments will be described below.

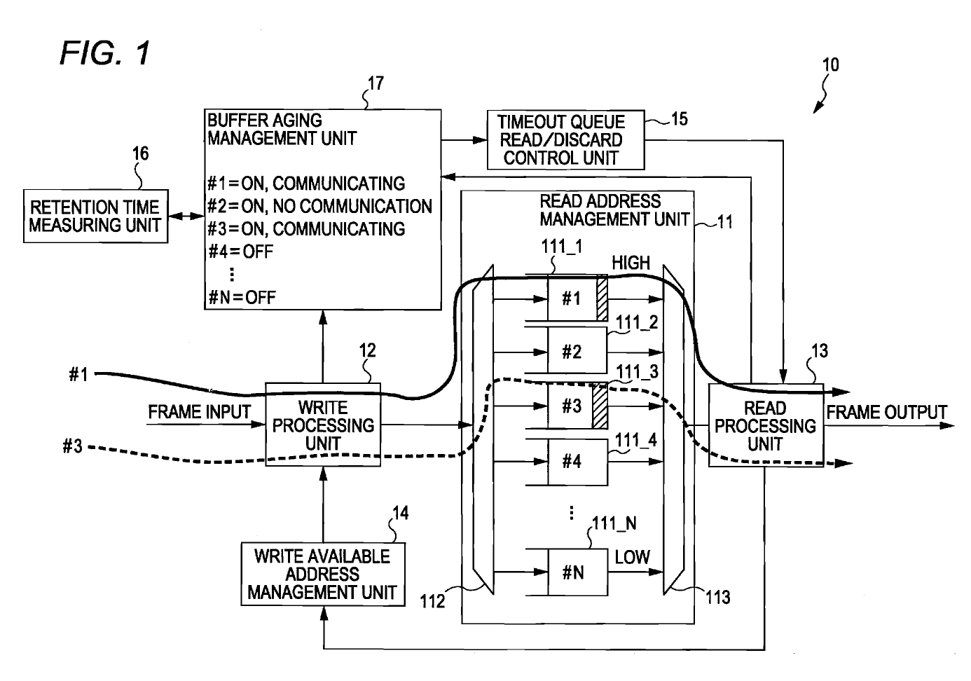

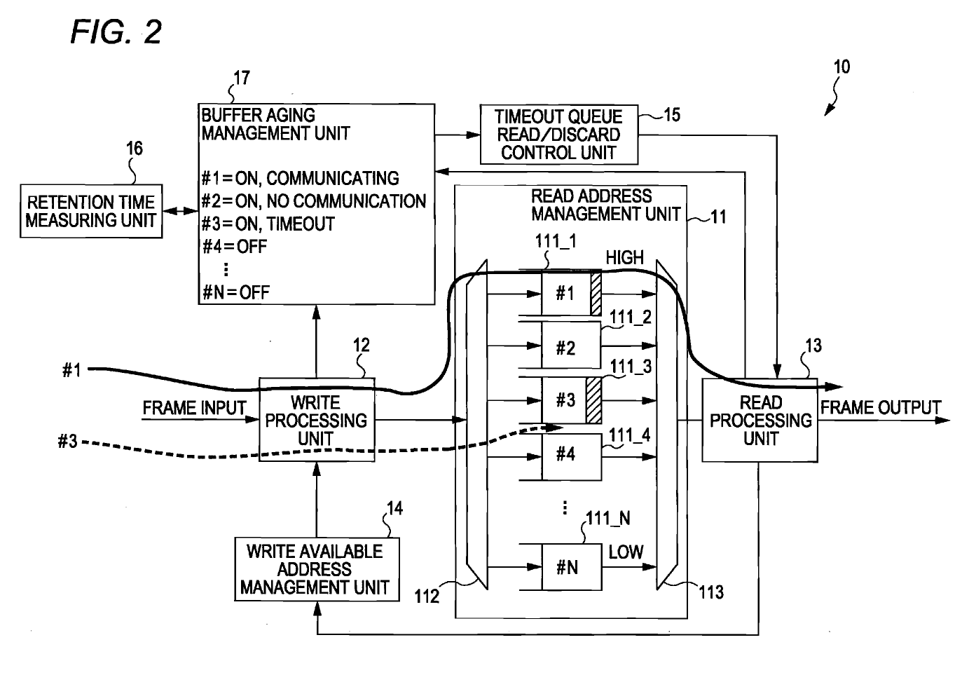

FIGS. 1 and 2 are block diagrams of an internal configuration of a frame transfer apparatus in a first embodiment. FIG. 1 shows a state of communication without retention in each class. FIG. 2 shows a state in which a timeout occurs in the class of #3.

A frame transfer apparatus 10 shown in FIG. 1 comprises a read address management unit 11, a write processing unit 12, a read processing unit 13, a write available address management unit 14, a timeout queue read/discard control unit 15, a retention time measuring unit 16, and a buffer aging management unit 17. Among these components, the read address management unit 11 is composed of a plurality of classes 111-1, 111-2, 111-3, 111-4 . . . , each of which is composed of a FIFO memory, a write selector 112 for selecting a class into which a frame transmitted this time should be written from the plurality of classes 111-1, 111-2, 111-3, 111-4 . . . , and a read selector 113 for selecting a class from which to be read this time from the plurality of classes 111-1, 111-2, 111-3, 111-4 . . . .

N classes 111-1, 111-2, 111-3, 111-4 . . . , 111-N of #1 to #N of the read address management unit 11 are classes into which frames of descending order of priorities are written. According to an aspect of an embodiment, for example, complete priority control in which the turn of a class to read comes when all classes that have higher priorities are vacant is applied to the above classes.

The read processing unit 13 fetches a frame sequentially to output the frame to a network while switching the read selector 113 according to an algorithm of the complete priority control. The write available address management unit 14 is notified of an address that becomes vacant as a result of a frame being read by the read processing unit 13. The write available address management unit 14 manages available addresses in each of the N classes 111-1, 111-2, 111-3, 111-4 . . . , 111-N provided in the read address management unit 11. Then, the write available address management unit 14 notifies the write processing unit 12 of information about such available addresses.

The write processing unit 12 looks at the priority of an input frame and refers to available addresses notified from the write available address management unit 14 to switch the write selector 112 to write the input frame into an available address of the class in accordance with the priority of the frame. Each of the classes 111-1, 111-2, 111-3, 111-4 . . . , 111-N is composed of a FIFO memory and first-in first-out control in which a frame written first is also read first within the same class is applied. However, a frame once written into an address of a class is managed as an order in a list separately from write addresses without the address being rewritten toward the head (or front) of the list each time a frame written earlier is read out and only the order in the list is rewritten each time a frame written earlier is read out.

After receiving a notification of write timing and a class into which a frame has been written from the write processing unit 12, that of read timing and a class from which a frame has been read from the read processing unit 13, and that of a timeout period passage described later from the retention time measuring unit 16, the buffer aging management unit 17 performs the following management work for all classes 111-1, 111-2, 111-3, 111-4 . . . , 111-N of #1 to #N provided in the read address management unit 11

The buffer aging management unit 17 manages whether the class is currently used (ON) or not (OFF), there is currently a frame that has been written into the class and has not been read (communicating) or the class is currently vacant (no communication), or as shown in FIG. 2, a frame at the head (front) of the class has not yet been read (timeout) after a predetermined timeout period passes from the time when the frame was placed (designated or pointed) at the head.

For each of the classes 111-1, 111-2, 111-3, 111-4 . . . , 111-N of #1 to #N, if the class is vacant, the retention time measuring unit 16 measures the time passed after a new frame is written into the class. And/Or, if frames are already stored in the class, the retention time measuring unit 16 measures the time passed after a frame is read out from the class and another frame is placed at the head (front) of reading order of the class.

Then, when the measured time passes a predetermined timeout period, the buffer aging management unit 17 is notified that a timeout period has passed. Upon receipt of the notification, the buffer aging management unit 17 changes the state of the class from “communicating” to “timeout”. If a class is changed to “timeout” by the buffer aging management unit 17, the timeout queue read/discard control unit 15 is notified of information about which class has been changed to “timeout”. Upon receipt of the notification, the timeout queue read/discard control unit 15 instructs the read processing unit 13 to read and discard a frame placed at the head of a class by specifying the class. Upon receipt of the instruction, the read processing unit 13 reads the frame placed at the head of the specified class and discards it. The frame read by the read processing unit 13 is not sent out to a network.

FIG. 2 shows a state in which a timeout has occurred in the class 111-3 of #3.

With frames remaining in the read address management unit 11 being discarded in this manner, wasteful frame transmission is reduced and efficient use of limited network resources is promoted. If a new frame to be written is further transmitted to a class when the class is full and no frame can be written into the class, like a conventional technology, the frame newly transmitted is discarded by the write processing unit 12. Here, if a technology to discard a frame by the read processing unit 13 in the present embodiment is adopted, opportunities when the class becomes full will decrease and, as a result, opportunities of a new frame being discarded will also decrease.

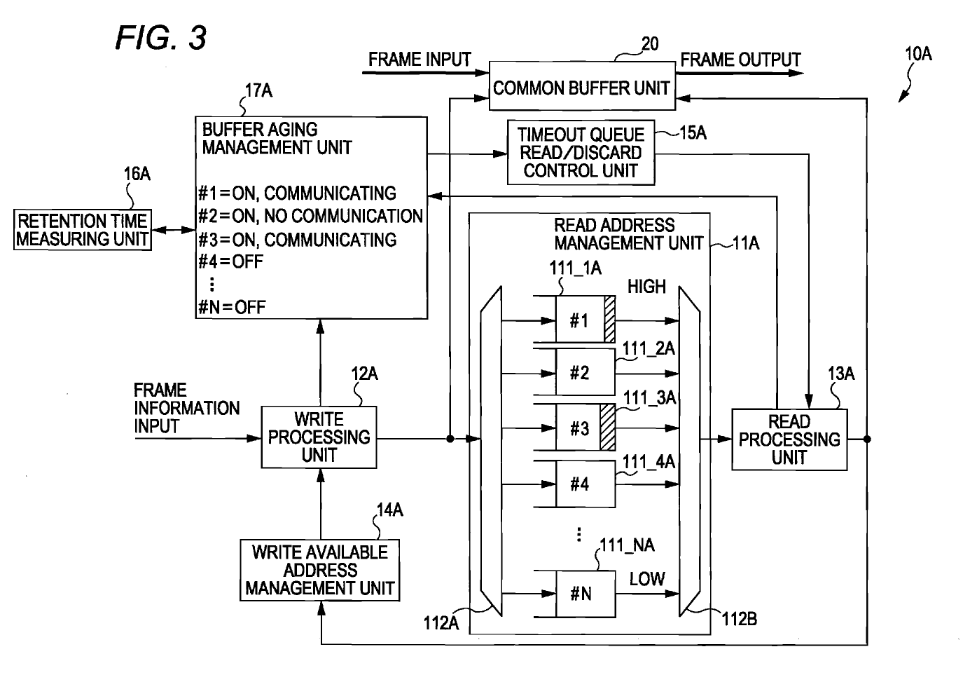

FIG. 3 is a diagram showing a frame transfer apparatus in a second embodiment.

In addition to a configuration (A is added to the same numerals as those in FIG. 2) similar to that in FIG. 2, a common buffer unit 20 is shown in a frame transfer apparatus 10A shown in FIG. 3. The common buffer unit 20 is composed of freely writable/readable memories. The configuration parts or components shown in FIG. 3 are similar to that in FIG. 2 and handle only information about frame priorities, frame size and the like, however, a frame itself is written into the common buffer unit 20 before being read from the common buffer unit 20.

When a new frame arrives after being transmitted, the frame is sent to the common buffer unit 20 and information such as the header of the frame is sent to a write processing unit 12A. The write processing unit 12A obtains information about available addresses from a write available address management unit 14A. Next, the write processing unit 12A gives a write address of the new frame to the common buffer unit 20 to cause the common buffer unit 20 to write the frame to the instructed write address in the common buffer unit 20. Further, the write processing unit 12A causes the common buffer unit 20 to write information (including information of the write address in the common buffer unit 20 to which the frame has been written) about the frame into the class according to the frame's priority in a read address management unit 11A.

Moreover, a read processing unit 13A reads out frame information from the read address management unit 11A according to a predetermined priority algorithm. Next, the read processing unit 13A notifies the common buffer unit 20 of a read address of a frame itself corresponding to the frame information read by the read processing unit 13A. Next, the read processing unit 13A causes the common buffer unit 20 to read the frame itself corresponding to the frame information and transmit the frame to a network.

Further, if notified from a timeout queue read/discard control unit 15A that a timeout occurred in some class, the read processing unit 13A reads out information about the first frame in the class (for example, oldest frame in the class). Next, the read processing unit 13A returns to the write available address management unit 14A an address in the common buffer unit 20 contained in the frame information read out by the read processing unit 13A and into which at the common buffer unit the frame has been written. The frame is thereby discarded without being read out from the common buffer unit 20. Thus, FIFO memories for each class may be constructed inside the common buffer unit 20 by separating frame information and a frame itself and controlling the write addresses and read addresses in the common buffer unit 20 based on the frame information.

Here, in both the above first and second embodiments, a frame placed at the head of a class in which a timeout occurred is discarded. However, the fact that a timeout of a frame placed at the head occurred may suggest that all frames written in the class are now useless because of delayed opportunities of reading. Therefore, when a timeout occurs in some class, all frames that are written in the class when the timeout occurs may be discarded.

In addition, the embodiments include all aspects in which a frame placed at the head of a class in which a timeout occurs is discarded and, as described above, all frames written in the class at the time of timeout may be discarded. Also, only a frame at the head may be discarded. Also, a predetermined number of first frames such as first two or three frames may be discarded.

The embodiments can be implemented in computing hardware, including a controller or CPU, computer readable media, such as memories, and/or software. Further, any combinations of the described functions/features/operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A frame transfer apparatus for transmitting frames, comprising:
a common storage unit having a plurality of areas;
a write control unit storing a transmitted frame, in an area fitting the frame from among the plurality of areas;
a read control unit reading the frame stored in the area in order of storage;
clock units each provided by associating with one or more areas among the plurality of areas to measure a time after a frame is stored in a corresponding area; and
a frame discarding unit that, when a measured time by any clock unit among the clock units exceeds a permissible retention time, discards among frames stored in the area corresponding to the clock unit at least a frame positioned first in the area.

2. The frame transfer apparatus according to claim 1, wherein, when a measured time by any clock unit among the clock units exceeds the permissible retention time, the frame discarding unit discards all frames written in the area corresponding to the clock unit.

3. The frame transfer apparatus according to claim 1, wherein the write control unit writes a transmitted frame into the area corresponding to a priority of the frame, and
the read control unit preferentially reads frames from, among the plurality of areas, areas having higher priorities.

4. A method of transmitting frames from a plurality of memory areas, comprising:
storing the frames in one of the memory areas;
reading the frames stored in the memory area in order of storage of the frames in the memory area;
measuring a time after each frame is stored in the memory area and/or placed at head of reading order of the memory area; and
when the measured time exceeds a permissible retention time, discarding from among the frames stored in the memory area, at least one frame positioned first in the memory area.
